(19) United States
(12) Patent Application Publication
(10) Pub. No.: US 2010/0274698 A1
(43) Pub. Date: Oct. 28, 2010

(54) Soft Limits for Credit Card Transactions

(75) Inventors: Sukadev Bhattiprolu, Beaverton, OR (US); Haren Myneni, Beaverton, OR (US); Malahal R. Naineni, Beaverton, OR (US); Badari Pulavarty, Beaverton, OR (US); Chandra Seetharaman, Beaverton, OR (US); Narasimha N. Sharoff, Beaverton, OR (US)

Correspondence Address: Lieberman & Brandsdorfer, LLC, 802 Still Creek Lane, Gaithersburg, MD, 20878, US

(73) Assignee: INTERNATIONAL BUSINESS MACHINES CORPORATION, Armonk, NY (US)

(21) Appl. No.: 12/430,229

(22) Filed: Apr. 27, 2009

(51) Int. Cl. G06Q 40/00

(52) U.S. Cl. 705/35

(57) ABSTRACT

A method, system, and article are provided for effectively managing a financial account for fraud prevention. The account is provided with a soft credit limit parameter and a tool for management of the soft credit limit parameter. The soft credit limit is in addition to a hard credit limit. More specifically, the hard credit limit is static and fixed by a credit issuing authority. In contrast, the soft credit limit is amendable under different circumstances and in conjunction with the tool is managed by the holder of the account.

### BACKGROUND OF THE INVENTION

1. Technical Field

This invention relates to a method and system for management of credit limits in a financial transaction. More specifically, the invention relates to employing and managing a soft credit limit for an underlying financial account for management of one or more financial transactions.

2. Description of the Prior Art

A credit limit is the maximum amount of credit that a bank or other lender will extend to a customer, or the maximum that a credit card company will allow a card holder to borrow on a single card. More specifically, a credit limit is the explicit borrowing ceiling set by a lender for a particular customer. The credit facility having a credit limit can take many forms, both secured and unsecured. The line of credit, letter of credit, and credit card all have a credit limit. An example of secured debt would be the home equity line of credit, where the credit limit decision would take into account the amount of home equity accumulated. On the other hand, the credit limit on a credit card, which is unsecured, would be based entirely upon creditworthiness.

Credit limits are employed by financial institutions as a tool to control borrowing and lending of money. Based upon available funds and historical usage of funds, the financial institution will employ a mathematical formula to determine the credit limit for an individual or business entity. It is the responsibility of the individual or business entity to properly manage the credit limit to ensure that they do not borrow money in excess of the credit limit. However, there are circumstances when the credit limit is exceeded and this is out of the control of the individual or business entity. For example, in the case of a credit card that is stolen or used by an unauthorized person, the credit limit may be exceeded because the user of the card is not aware of the credit limit.

To enforce the theory of the credit limits, the financial institution underwriting the credit limit may apply a surcharge for one or more transactions that exceed the credit limit. This enforcement is a tool to mitigate abuse of exceeding the credit limit. At the same time, the financial institution may not approve any transaction that will cause the credit limit to be exceeded. Accordingly, the credit limit may be an actual monetary ceiling which the financial institution will not allow to be exceeded.

The credit limit described above is a hard limit in that once this value is exceeded there is no credit remaining. However, there is no warning system that informs an account holder that they are nearing the credit limit. The account holder may have a plurality of accounts with each account having different credit limit. Therefore, the account holder may not be aware that a transaction will cause the account to exceed the credit limit as they are submitting a transaction to the financial institution.

There is a need to apply a tool in the credit market to ensure that a credit limit is not attained or exceeded for either a specific transaction or a combination of transactions. The tool should inform an authorized account holder that the credit limit is nearing prior to execution of the transaction. In addition, there is a need to apply a tool in the credit market to maintain control of the account by limiting credit authorization on a transaction basis. The credit limits applied with the tool are an added layer of security to the prior art hard credit limit, and function in conjunction therewith.

### SUMMARY OF THE INVENTION

This invention comprises a method, system, and article for creation and management of a soft credit limit for an underlying financial account.

In one aspect of the invention, a method is provided for management of an underlying financial account. A hard credit limit is established for the underlying account. Additionally, a soft credit limit is employed for the underlying financial account. The soft credit limit is any credit amount this is less than or equal to the hard credit limit. A value for the soft credit limit is set, and one or more transactions on the account are monitored. The process of monitoring the account includes both the hard and soft credit limits. Authorization of the transaction is declined in response to the transaction exceeding the soft credit limit, and the transaction is allowed in response to the transaction being less than both of the credit limits. A declined transaction includes prevention of completion of the transaction. Similarly, allowance of the transaction includes completion of the transaction.

In another aspect of the invention, a computer system is provided with a processor in communication with memory. A financial account is provided on a remote server with a hard credit limit. A transaction on the account that exceeds the hard credit limit is considered a fraudulent activity. Similarly, a soft credit limit is established by a user manager in communication with the account. The soft credit limit is any credit amount less than or equal to the hard credit limit. A transaction manager is provided local to the server and in communication with the user manager to monitor a transaction to the account. The transaction manager oversees both the hard and soft credit limits. More specifically, the transaction manager declines authorization of the transaction in response to the transaction exceeding at least one of the credit limits, and the transaction manager allows the transaction in response to the transaction being less than both of the credit limits.

In yet another aspect of the invention, an article is provided with a computer-readable carrier including computer program instructions configured to manage an underlying financial account. Instructions are provided to establish a hard credit limit for the underlying account, and to employ a soft credit limit for the underlying financial account. The soft credit limit is any credit amount this is less than or equal to the hard credit limit. In addition, instructions are provided to set a value for the soft credit limit, and to monitor a transaction to the account. The monitoring instructions oversee both the hard and soft credit limits set for the account. Authorization of the transaction is declined in response to the transaction exceeding the soft credit limit, and allowed in response to the transaction being less than both of the credit limits.

Other features and advantages of this invention will become apparent from the following detailed description of the presently preferred embodiment of the invention, taken in conjunction with the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention unless otherwise explicitly indicated. Implications to the contrary are otherwise not to be made.

FIG. 1 is a flow chart illustrating setting the soft credit limit with an account held by a financial institution.

FIG. 2 is a flow chart illustrating setting parameters for the soft credit limit.

FIG. 3 is a flow chart illustrating employing the soft credit limit for fraud prevention, according to the preferred embodiment of this invention, and is suggested for printing on the first page of the issued patent.

FIG. 4 is a block diagram illustrating a set of tools for employing and managing a soft credit limit for an underlying account.

### DESCRIPTION OF THE PREFERRED EMBODIMENT

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

The functional units described in this specification have been labeled as a manager. A manager may be implemented in programmable hardware devices such as field programmable gate arrays, programmable array logic, programmable logic devices, or the like. The manager may also be implemented in software for execution by various types of processors. An identified manager of executable code may, for instance, comprise one or more physical or logical blocks of computer instructions which may, for instance, be organized as an object, procedure, function, or other construct. Nevertheless, the executables of an identified manager need not be physically located together, but may comprise disparate instructions stored in different locations which, when joined logically together, comprise the manager and achieve the stated purpose of the manager.

Indeed, a manager of executable code could be a single instruction, or many instructions, and may even be distributed over several different code segments, among different applications, and across several memory devices. Similarly, operational data may be identified and illustrated herein within the manager, and may be embodied in any suitable form and organized within any suitable type of data structure. The operational data may be collected as a single data set, or may be distributed over different locations including over different storage devices, and may exist, at least partially, as electronic signals on a system or network.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

Furthermore, the described features, structures, or characteristics may be combined in any suitable manner in one or more embodiments. In the following description, numerous specific details are provided, such as examples of recovery manager, authentication module, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

### Overview

A soft limit is a user implemented tool for managing usage of credit with a financial institution. The soft limit is employed to ensure that the hard limit is not exceeded, and/or that an individual transaction does not exceed a set value. Once the soft credit is established with a financial account, it may be adjusted and/or evaluated to ascertain pattern of usage.

### Technical Details

In the following description of the embodiments, reference is made to the accompanying drawings that form a part hereof, and which shows by way of illustration the specific embodiment in which the invention may be practiced. It is to be understood that other embodiments may be utilized because structural changes may be made without departing form the scope of the present invention.

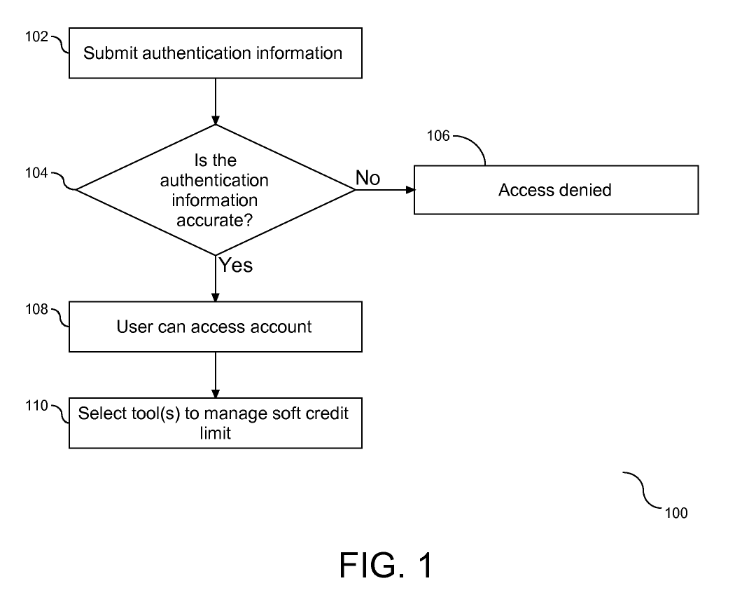

FIG. 1 is a flow chart (100) illustrating setting the soft credit limit with an account held by a financial institution. There are different mediums that are employed for accessing the account, including telephone, internet, personal, etc. Regardless of the medium employed, the person accessing the account must provide authentication information to ensure that they are authorized to access the account (102). Authentication information generally includes a user name and associated password. There are various known forms of authentication and associated authentication mechanisms. However, they are beyond the scope of this application. Once the authentication information is present, it is then determined if the person presenting the authentication information to access the account is authorized (104). A negative response to the determination at step (104) is an indication that the user did not present valid authentication information, and the user will be denied access to the account (106). Conversely, a positive response to the determination at step (104) is an indication that the user presented valid authentication information, and the user is presented with access to the account (108). There are different tools that may be presented to the user once access is supported, including soft credit tools. The user may select among the soft credit tools available to employ a soft credit with the underlying account (110). Once the user has completed their selection, the selected parameters of the soft credit are applied to the underlying account.

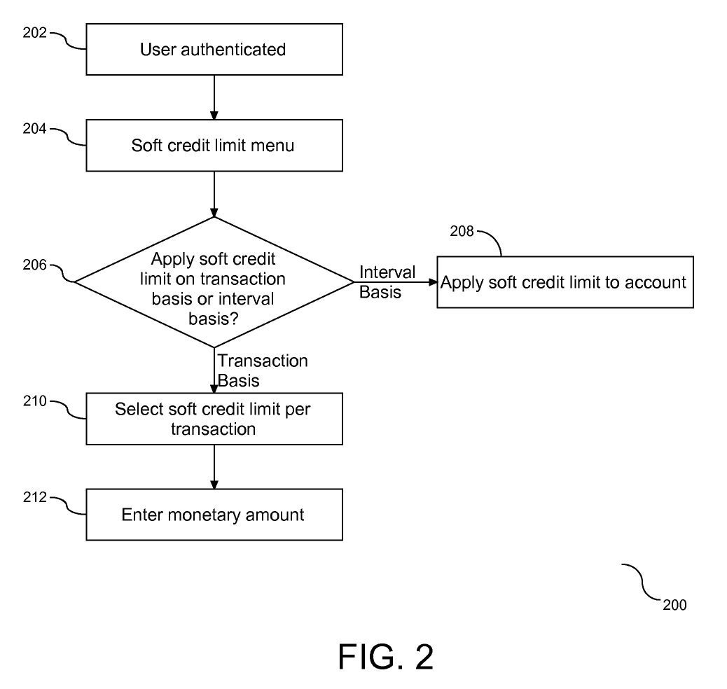

As noted above, there are different parameters that may be invoked for establishing and defining the soft credit limit. FIG. 2 is a flow chart (200) illustrating an example of establishing some of these parameters. Once the user has been authenticated (202), the user is presented with a menu of options available to establish and/or amend the soft credit limits for the account (204). In one embodiment, the soft credit limit can be a monetary amount established for the account in its entirety. Similarly, in one embodiment, the soft credit limit can be a monetary amount established for each individual transaction that transpires on the account. Initially, the user must determine if the soft credit limit will be applied on a transactional basis or an interval basis (206). A selection of the interval basis will apply the soft credit limit on the totality of the monetary amount of the transactions regardless of the quantity of transactions. In one embodiment, the time interval may be set by the hour, day, week, month, year, etc. Following selection of an interval, the user applies a soft credit limit to the account (208). The soft credit limit can be any monetary amount up to, but not exceeding, the actual underlying credit limit of the account as established by the monetary institution. Conversely, a selection of the transaction basis presents the user with a selection of the soft credit limit to be applied as the maximum quantity that may be employed with each individual transaction (210). The user enters a monetary amount, i.e. the soft credit limit, for the transaction (212). In one embodiment, the user may also apply both restrictions on the underlying account, including a restriction on the account in it's entirety as demonstrated at step (208), or a restriction on the monetary amount applied per transaction. Accordingly, a soft credit limit may be employed on one or more characteristics of the underlying account.

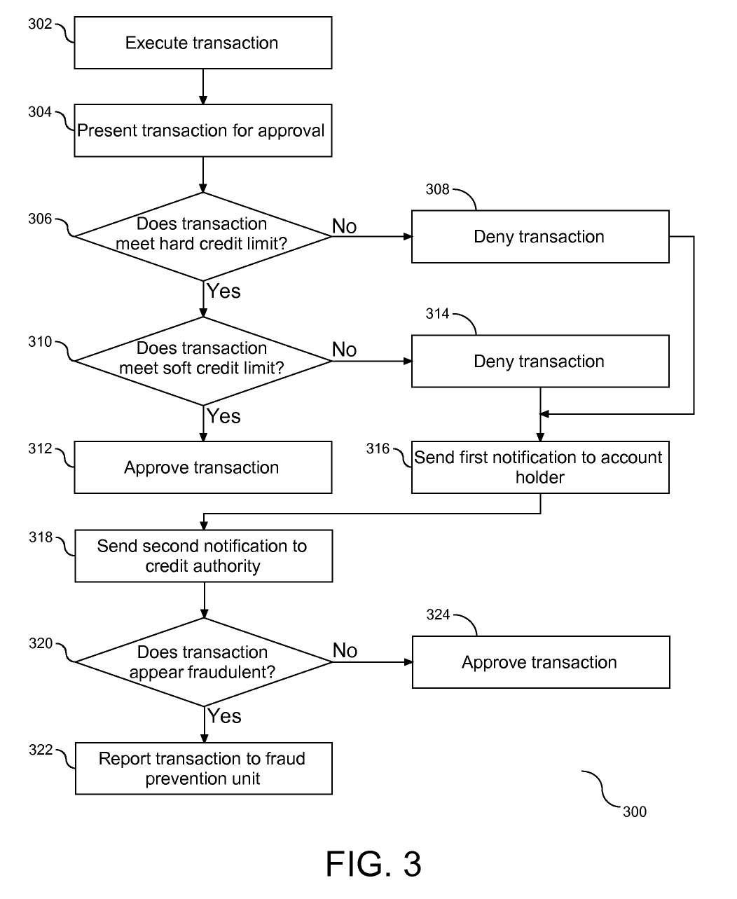

The soft credit limit may be employed by the user to facilitate management of their financial account, and at the same time, may be employed as a fraud prevention tool by both the account user and the underlying financial institution. FIG. 3 is a flow chart (300) illustrating employment of the soft credit limit for fraud prevention. As shown, a transaction is executed (302) and presented for approval (304). The approval process includes a determination as to whether the transaction abides by the parameters of the hard credit limit (306). A negative response to the determination at step (306) is followed by a denial of the transaction (308). Conversely, a positive response to the determination at step (306) includes a determination as to whether the transaction abides by the parameters of the soft credit limit (310). A positive response to the determination at step (310) is followed by approval of the transaction. Conversely, a negative response to the determination at step (310) is followed by a denial of the transaction (312). Following steps (308) and (312), a first notification of the transaction denial is sent to the owner of the account (314) and a second notification of the transaction denial is sent to the underlying financial institution as a potential fraudulent use of the credit (316). It is then determined if the denied transaction appears fraudulent (318). There are different parameters and algorithms that may be employed for determining fraudulent activity on an account. For a hard credit limit, the transaction alone may be deemed a fraudulent activity. However, a soft credit limit is a user employed limit on the account and exceeding the soft credit limit does not necessarily deem the transaction fraudulent. Examples of those transactions characteristics that may be deemed fraudulent include, but are not limited to, exceeding one or more of the soft credit limit characteristics, or receiving more than one soft credit limit denial within a defined time interval. A positive response to the determination at step (318) is followed by reporting the transaction to a fraud prevention unit of the underlying financial institution (320), and may also include contacting the customer to report the transaction to their attention. Conversely, a negative response to the determination at step (318) is following by approving the transaction. Accordingly, transactions applied to an account with a soft credit limit may be monitored to assess a pattern of behavior associated with the account and in a similar manner to a hard credit limit characteristic to determine if there is fraudulent or some unauthorized use of the account.

Once the soft credit limit is applied to the underlying account, it affects all transactions on the account. If a transaction exceeds a parameter of the soft credit limit, the transaction will be rejected. The establishment of the soft credit limit is as effective as a hard credit limit. However, one significant distinction is that the soft credit limit is established by the user of the account, and not by the underlying financial institution. If the user wants to proceed with a transaction that does not abide by the established parameters of the soft credit limits, they can change the selected parameters for the transaction, and then re-establish the prior parameters for the account.

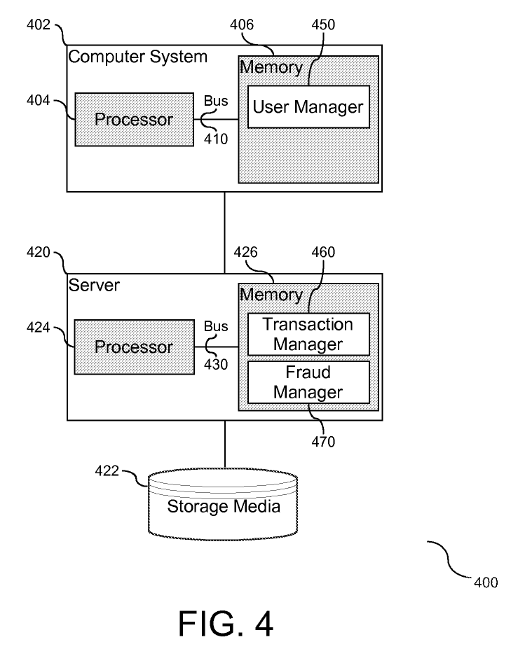

As shown in FIGS. 1-3, soft credit limits may be applied as a management tool for an underlying financial account. FIG. 4 is a block diagram (400) illustrating a set of tools for modifying and employing the soft credit limit to the account. As shown, a computer system (402) is provided with a processor unit (404) coupled to memory (406) by a bus structure (410). Although only one processor unit (404) is shown, in one embodiment, more processor units may be provided in an expanded design. The system (402) is shown in communication with a remote server (420) and storage media (422). Similar to the computer system (402), the remote server is provided with a processor unit (424) coupled to memory (426) by a bus structure (430). Although only one processor unit (424) is shown, in one embodiment, more processor units may be provided in an expanded design.

A user manager (450) is provided local to the computer system (402) and in communication with a transaction manager (460) local to the remote server (420). The user manager functions to establish a soft credit limit for an underlying financial account. The soft credit limits is any credit amount less than or equal to the hard credit limit. The transaction manager (460) functions to monitor a transaction with the account, including both the hard and soft credit limits. More specifically, the transaction manager (460) declines authorization of the transaction in response to the transaction exceeding at least one of the credit limits, and the transaction manager (460) allows the transaction in response to the transaction being less than both of the credit limits. An additional manager is provided in the form of a fraud manager (470). As shown, the fraud manager (470) is local to the remote server and is responsible for monitoring transactions declined in violation of the soft credit limit and evaluating a pattern associated with the declined transactions.

In one embodiment, user manager (450) may reside in memory (406) local to the computer system (402). Similarly, the transaction and fraud managers (460) and (470), respectively, may reside in memory (426) local to the remote server (420). However, the invention should not be limited to this embodiment. For example, in one embodiment, each of the managers (450), (460), and/or (470) may reside as hardware tools external to local memory of the respective computer system (402) and remote server (420), or they may be implemented as a combination of hardware and software. Similarly, in one embodiment, the managers (450), (460), and (470) may reside on a remote system in communication with the storage media (422). Accordingly, the managers may be implemented as a software tool or a hardware tool to employ and manage soft credit limits of a financial account.

In one embodiment, the invention is implemented in software, which includes but is not limited to firmware, resident software, microcode, etc. The invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, or transport the program for use by or in connection with the instruction execution system, apparatus, or device.

Embodiments within the scope of the present invention also include articles of manufacture comprising program storage means having encoded therein program code. Such program storage means can be any available media which can be accessed by a general purpose or special purpose computer. By way of example, and not limitation, such program storage means can include RAM, ROM, EEPROM, CD-ROM, or other optical disk storage, magnetic disk storage or other magnetic storage devices, or any other medium which can be used to store the desired program code means and which can be accessed by a general purpose or special purpose computer. Combinations of the above should also be included in the scope of the program storage means.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, random access memory (RAM), read-only memory (ROM), a rigid magnetic disk, and an optical disk. Current examples of optical disks include compact disk B read only (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks.

The software implementation can take the form of a computer program product accessible from a computer-useable or computer-readable medium providing program code for use by or in connection with a computer or any instruction execution system.

### ADVANTAGES OF THE EXEMPLARY EMBODIMENT OVER THE RELATED ART

Soft credit limits are employed with respect to a financial account as a tool for management thereof by both the user and an associated fraud prevention tool or manager. The soft credit limit functions in conjunction with the hard credit limit that is an innate characteristic of the underlying account. More specifically, the soft credit limit functions as a veneer over the hard credit limit to provide a granular management of the account on an interval basis, a transaction basis, or a combination of both bases. The soft credit limits can be enforced and operated at two levels, at one level the soft credit limits can be applied on a per transaction basis, and at a second level the soft credit limits can be applied on a time interval basis. For example, in one embodiment both levels can co-exist where there can be a hard limit amount, a soft limit monthly amount, and a limit per transaction. A transaction that violates any of the co-existing levels can be rejected. Accordingly, the soft credit limits may be applied in a tiered manner for control on a specified account.

### ALTERNATIVE EMBODIMENTS

It will be appreciated that, although specific embodiments of the invention have been described herein for purposes of illustration, various modifications may be made without departing from the spirit and scope of the invention. In particular, the user manager may be employed from a variety of mediums including telephone, electronic mail, electronic connection to a computer network, etc. Similarly, the underlying account may be in the form of a credit card. However, the invention should not be limited to this form of a financial account. Examples of other forms of financial accounts that may employ the soft credit limits and its associated parameters include, but are not limited to, a line of credit, a checking account, a savings account, etc. Regardless of the form of the account, the application of the soft credit limit functions as both a fraud detection tool and as a fraud prevention tool. In one embodiment, the soft credit limit may be set to zero when the holder of the subject account does not anticipate any transactions on the account. Accordingly, the scope of protection of this invention is limited only by the following claims and their equivalents.

We claim:

1. A method for management of an underlying financial account, comprising:
establishing a hard credit limit for the underlying account;
employing a soft credit limit for the underlying financial account, wherein the soft credit limit is any credit amount this is less than or equal to the hard credit limit;
setting a value for the soft credit limit;
monitoring a transaction to the account, including both the hard and soft credit limits; and
declining authorization of the transaction in response to the transaction exceeding the soft credit limit, including prevention of completion of the transaction, and allowing the transaction in response to the transaction being less than both of the credit limits, including completion of the transaction.

2. The method of claim 1, further comprising installing a soft credit limit per transaction, and declining authorization of the transaction in response to an amount for the transaction exceeding the soft credit limit per transaction.

3. The method of claim 2, wherein the soft credit limit is amendable by the user, with the maximum soft credit limit set by the hard credit limit.

4. The method of claim 1, further comprising assigning the soft credit limit directly to a time interval, wherein the time interval is selected from the group consisting of: day, week, and month.

5. The method of claim 1, further comprising amending the value assigned to the soft credit limit from a medium selected from the group consisting of: telephone, a distributed computer network, and access to the account.

6. The method of claim 1, further comprising monitoring transactions declined for violating the soft credit limit and evaluating a pattern associated with the declined transactions.

7. A computer system comprising:
a processor in communication with memory;
a financial account having a hard credit limit, wherein a transaction that exceeds the hard credit limit is considered a fraudulent activity;
a soft credit limit established by a user manager in communication with the account, wherein the soft credit limit is any credit amount less than or equal to the hard credit limit;
a transaction manager to monitor a transaction to the account, including both the hard and soft credit limits; and
the transaction manager to decline authorization of the transaction in response to the transaction exceeding at least one of the credit limits, and the transaction manager to allow the transaction in response to the transaction being less than both of the credit limits.

8. The system of claim 7, further comprising the user manager to install a soft credit limit on each transaction on the account, and the transaction manager to decline authorization of any transaction in response to an amount for the transaction exceeding the soft credit limit per transaction.

9. The system of claim 8, wherein the soft credit limit is amendable by the user, with the maximum soft credit limit set by the hard credit limit.

10. The system of claim 7, further comprising the user manager to assign the soft credit limit directly to a time interval, wherein the time interval is selected from the group consisting of: day, week, and month.

11. The system of claim 7, further comprising am amendment of the value assigned to the soft credit limit from a medium selected from the group consisting of: telephone, a distributed computer network, and access to the account.

12. The system of claim 7, further comprising the transaction manager in communication with a fraud manager to monitor transactions declined in violation of the soft credit limit and to evaluate a pattern associated with the declined transactions.

13. An article configured to manage an underlying financial account, the article comprising:
a computer-readable carrier including computer program instructions and to support configuration of the account, the instructions comprising:
instructions to establish a hard credit limit for the underlying account;
instructions to employ a soft credit limit for the underlying financial account, wherein the soft credit limit is any credit amount this is less than or equal to the hard credit limit;
instructions to set a value for the soft credit limit;
instructions to monitor a transaction to the account, including both the hard and soft credit limits; and
declining authorization of the transaction in response to the transaction exceeding the soft credit limit, including prevention of completion of the transaction, and allowing the transaction in response to the transaction being less than both of the credit limits, including completion of the transaction.

14. The article of claim 13, further comprising instructions to install a soft credit limit per transaction, and instructions to decline authorization of the transaction in response to an amount for the transaction exceeding the soft credit limit per transaction.

15. The article of claim 14, wherein the soft credit limit is amendable by the user, with the maximum soft credit limit set by the hard credit limit.

16. The article of claim 13, further comprising instructions to assign the soft credit limit directly to a time interval, wherein the time interval is selected from the group consisting of: day, week, and month.

17. The article of claim 13, further comprising instructions to amend the value assigned to the soft credit limit from a medium selected from the group consisting of: telephone, a distributed computer network, and access to the account.

18. The article of claim 13, further comprising instructions to monitor transactions declined for violation of the soft credit limit and evaluation of a pattern associated with the declined transactions.
